(19) United States
(12) Patent Application Publication
(10) Pub. No.: US 2025/0044077 A1
(43) Pub. Date: Feb. 6, 2025

(54) METHOD FOR MEASURING THE THICKNESS OF A VARNISH LAYER

(71) Applicant: ArcelorMittal, Luxembourg (LU)

(72) Inventors: Nathalie LABBE, Jury (FR); Shu Hui HAM, Volstroff (FR); Gwenaël LE NOC, Ars-sur-Moselle (FR); Pauline LEVERONE, Moulins-les-Metz (FR); Jean-Pierre LEBACQ, Guenange (FR)

(21) Appl. No.: 18/715,434

(22) PCT Filed: Dec. 7, 2022
(86) PCT No.: PCT/IB2022/061875

§ 371 Date: May 31, 2024

(30) Foreign Application Priority Data
Dec. 9, 2021 (WO) PCT/IB2021/061501

(51) Int. Cl. G01B 11/06

(52) U.S. Cl. CPC G01B 11/0625

(57) ABSTRACT

A method for estimating the thickness of a varnish coating, having a thickness from 0.5 to 5 μm, of a moving steel substrate including a varnish coating including the steps of i. lighting said moving coated steel substrate with an illumination source forming an incident angle from 51° to 61° with respect to the normal of said steel substrate, ii. p-polarizing the light after reflection on said moving steel substrate and measuring the intensities of the light after reflection on said moving steel substrate, iii. assessing an absorbance spectrum of said varnish coating in said wavelength range iv. assessing an area under the curve of said absorbance spectrum A_{MEAS} v. estimating the varnish thickness using said area under the curve and a function linking a varnish thickness and an area under the curve of an absorbance spectrum of said coating.

The present invention relates to a method for estimating the thickness of a varnish coating, having a thickness from 0.5 to 5 m, of a moving steel substrate.

This invention is particularly intended for estimating the thickness of a varnish coating of an electrical steel strip.

### BACKGROUND

After an annealing step, the electrical steels are usually coated with a varnish. It permits to insulate them from the flow of electricity and reduce the eddy current. This varnish is generally coated in a form of a wet film and then cured to obtain a reticulate dry film having a thickness from 0.8 to 5.0 μm.

After the curing, the varnish thickness is measured to control the quality of the coated steel strip and adapt the key coating process parameters.

### SUMMARY OF THE INVENTION

A purpose of the invention is to provide a method permitting to estimate the thickness of a varnish layer coated on a running steel substrate.

The present invention relates to a method for estimating the thickness of a varnish coating, having a thickness from 0.5 to 5 m, of a moving steel substrate 1 comprising a varnish coating 2 comprising the steps of:
i. lighting said moving coated steel substrate with an illumination source L including wavelengths from 2.7 to 3.7 m and forming an incident angle from 51° to 61° with respect to the normal of said steel substrate,
ii. after reflection on said moving steel substrate, p-polarizing the light and measuring the intensities in a wavelength range W_{MEAS}, at least from 2.7 to 3.7 μm, of the light,
iii. determining an absorbance spectrum A_{MEAS} of said varnish coating at least in said wavelength range W_{MEAS}, using a reference spectrum and the measured intensities in step ii.,
iv. determining an area under the curve of said absorbance spectrum A_{MEAS} at least in said wavelength range W_{MEAS},
v. estimating the varnish thickness using said area under the curve and reference values linking an area under the curve of an absorbance spectrum of said coating to a varnish coating thickness.

### BRIEF DESCRIPTION OF THE DRAWINGS

FIG. 1 embodies a setup to perform the claimed process steps.

FIG. 2 embodies the third step of the process.

FIG. 3 illustrates the relationship between the area under the curve of the absorbance spectrum of a varnish coating and the thickness of the varnish coating for a lighting done at an angle of 56° from the surface normal using a polarizer in front of the camera, oriented in such a way that only that only the p-polarized rays are captured.

FIG. 4 illustrates the relationship between the area under the curve of the absorbance spectrum of a varnish coating and the thickness of the varnish coating for a lighting done at an angle of 56° from the surface normal °.

### DETAILED DESCRIPTION

The method is applied after a varnishing operation. Said varnishing operation can comprise two steps: a coating step where a wet film is deposited on said steel substrate and a drying step where said wet film is dried and reticulated.

In the step i., the goal is to illuminate the moving coated steel substrate with a light source, emitting a known spectrum, such that at least a part of the rays passes through the varnish coating and is reflected on the steel substrate.

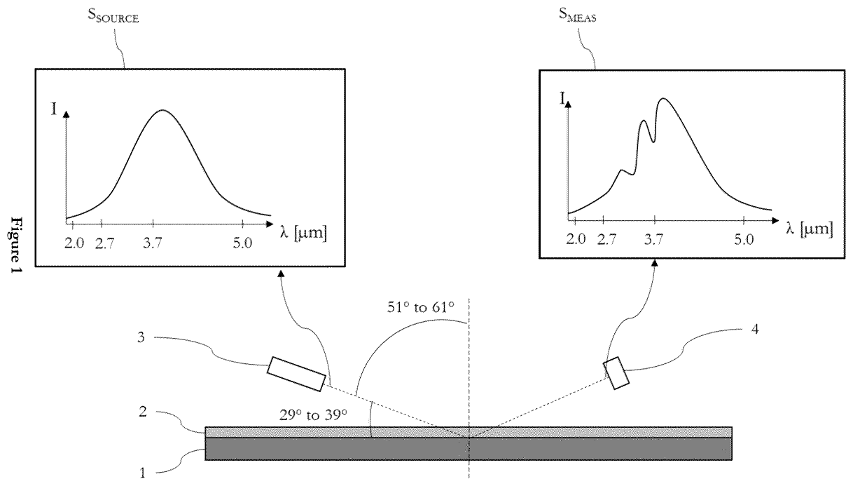

As illustrated in FIG. 1, the light source 3 illuminates the moving steel substrate 1 coated with a varnish layer 2.

As illustrated in FIG. 1 by the spectrum S_{SOURCE}, the light emitted by the light source 3 is preferably a broadband light, meaning that the source produces a broad, continuous spectrum of frequencies at least from 2.7 to 3.7 μm.

Preferably, in step i., the lighting is done by means of spectrally neutral illuminating source.

Preferably, said illumination source L and said moving coated steel substrate are spaced from 20 cm to 60 cm. It means that the light travels from 20 cm to 60 cm before being reflected by the moving coated steel substrate. Preferably, the illumination source L is configured to illuminate an area having a width as wide as the strip width and a length of at least 20 mm, even more preferably 30 mm.

In the step ii., the goal is to p-polarize the light passed through the varnish coating, reflected by the steel substrate and to measure the intensity, at least in the wavelength range W_{MEAS}, to obtain a spectrum S_{MEAS}.

As illustrated in FIG. 1, any intensity recording means, such as a camera 4, can be used to measure the intensities of the rays reflected on the steel substrate 1 and determine the spectrum S_{MEAS} of the reflected rays.

Moreover, the p-polarization can be done by any p-polarizing means. This p-polarisation can be done for example by a polarizer, such as a wire grid polarizer.

Preferably, said moving steel substrate and said intensity recording, such as a camera, are spaced from 50 cm to 150 cm. It means that the reflected light travels from 50 cm to 150 cm before entering the intensity recording means.

Preferably, a distance between the moving steel substrate and said p-polarizing means, such as a wire grid polarize, is from 50 cm to 150 cm. It means that the reflected light travels from 50 cm to 150 cm before entering the p-polarizing means.

The combination of the distance disclosed hereabove permits to have a robust measurement even when the moving steel substrate is vibrating. Indeed, without to be bound by any theory, this permits to reduce the risk of optical misalignment due to the vibrations of the moving coated steel strip.

In the step iii., the goal is to determine the absorbance spectrum A_{MEAS}, at least in the wavelength range W_{MEAS}, of the varnish coating.

The man skilled in the art knows how to assess the absorbance spectrum of a varnish coating using a reference spectrum, S_{REF}, and the measured spectrum, S_{MEAS}, e.g. the measured intensities in step ii.

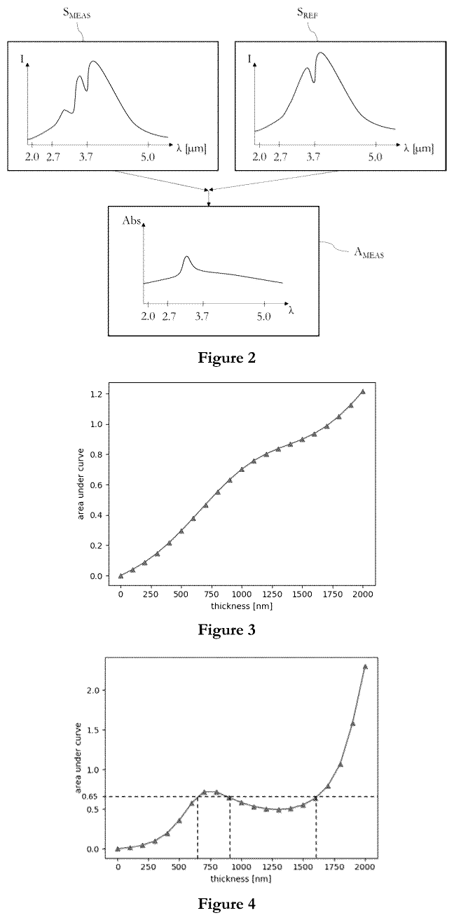

For example, this can be done by using a spectrum, S_{REF}, of p-polarized rays reflected on a non-coated steel substrate, as illustrated in FIG. 2, or on a laboratory calibrated reference signal or a computed reference. A non-coated steel substrate is a steel substrate which is not coated by a varnish layer.

The use of such spectra permits to take into consideration variation in intensities due to the environment, e.g. substrate variation, fluctuations and inhomogeneity in lighting, so as to better assess the absorbance only due to the coating layer.

This can be done using a computing means having access to the measured intensities in step ii. and to a database comprising at least one reference spectrum.

In the step iv. the goal is to determine the area under the curve of the varnish coating absorbance spectra, at least in the wavelength range W_{MEAS}. The man skilled in the art knows how to determine such an area under the curve based on an absorbance spectrum. For example, the step iv. can comprise a baseline correction step to isolate the absorbance peak from the global absorbance spectrum.

This can be done using a computing means having access to the absorbance spectrum A_{MEAS} assessed in step iii.

In the step v., the goal is to estimate the thickness of the varnish coating.

In order to do that, a relation between the area under the curve and the varnish coating has to be established. This can be done by doing the steps i. to iv. for varnish coated steel strip having a known coating thickness.

The step v. can be done using a computing means having access to the area under the curve assessed in step iv. and a database comprising area under the curve values associated to varnish thickness values.

For example, in FIG. 3, the area under curve of 21 different thickness has been calculated and thus permit to plot a curve linked the area under curve and the varnish coating thickness.

It has surprisingly been found that using the intensities of rays forming an incident angle from 51° to 61° with respect to the normal of said steel substrate, a quasi-linear variation between the area under curve of step iv. and the varnish thickness can be obtained when studying the p-polarized spectrum. More importantly, it permits linking of each value of an area under the curve to only one varnish thickness value.

Indeed, as shown in FIG. 3, when the light source and the surface of said steel substrate forms the claimed angle, a value of an area under the curve corresponds only to one varnish thickness value.

On the contrary, as shown in FIG. 4, when the light source uses a common setup where the light source and the surface of said steel substrate forms an angle of 45°, a non-linear response is measured, i.e. a value of an area under the curve can correspond to more than one varnish thickness. For example, in FIG. 4, for an area under curve of 0.65 correspond three thickness values: 650 nm, 900 nm and 1600 nm.

Apparently, the claimed incident angle of the illumination source combined with the p-polarisation of the measured rays has a synergetic effect permitting to avoid, or at least strongly reduce, interferences. It permits to link each value of an area under the curve to only one varnish thickness value.

Moreover, measuring the intensity in a wavelength range from 2.7 to 3.7 μm permits to measure the reflected light beam in the range where the absorbance of varnish coating is high. This is particularly true for the varnish coating used for electrical steels and/or for thin layer, e.g. having a thickness smaller than 5 m.

Preferably, said steel substrate is an electrical steel. Electrical steel comprises 0 to 6 weight percent of silicon. The electrical steels can be divided into two categories: the non-oriented steel and the oriented steel. Electrical steels are used to manufacture goods having specific magnetic properties, e.g. stator and rotor of electric motors, transformers and turbine of windmill.

Preferably, said varnish coating has a thickness from 0.5 to 6 m. Preferably, said varnish coating has a thickness from 0.5 to 2 μm.

Preferably, said varnish coating is a water-based solution comprising 25 to 75 weight percent of resin, 5 to 15 weight percent of solvent and a balance consisting of water. For example, the varnish coating comprises dry extract between 30-50 weight percent composed of acrylic resin and phosphate pigments, co-solvent (alcohol) 5-10 weight percent and a balance consisting of water. In another example, the varnish coating comprises dry extract of 40-60 weight percent being a mix of polyurethane resin and aluminium and silicon oxide, co-solvent (alcohol) 5-10 weight percent and a balance consisting of water.

Preferably, in step i., said light source L forms an angle from 530 to 590 with respect to the normal of said steel substrate. Apparently, such an angle range permits to have an even more linear relationship between the area under curve and the coating thickness. Even more preferably, in step i., said light source forms an angle from 550 to 570 with respect to the normal of said steel substrate.

Preferably, in step i., said light source L includes wavelength from 1.0 to 5.0 m and said wavelength range W_{MEAS} is at least from 1.0 to 5.0 μm. Such a range permits to increase the range of wavelength emitted by the light source and that can be then measured in step ii. and processed in steps iii. and iv. which permits to increase the accuracy of the estimation.

Preferably, in step i., the whole width of the moving steel substrate is lighted.

Preferably, in said step ii., said measure is done by means of a hyperspectral camera.

1-10. (canceled)

11: A method for estimating the thickness of a varnish coating having a thickness from 0.5 to 6 m, the varnish coating being on a moving steel substrate, the method comprising the steps of:
i. lighting the moving coated steel substrate with an illumination source including wavelengths from 2.7 to 3.7 m and forming an incident angle from 51° to 61° with respect to the normal of a steel substrate;
ii. after reflection on the moving steel substrate, p-polarizing the light and measuring intensities in a wavelength range W_{MEAS}, at least from 2.7 to 3.7 μm, of the light,
iii. determining an absorbance spectrum A_{MEAS} of the varnish coating at least in the wavelength range W_{MEAS}, using a reference spectrum and the measured intensities in step ii.,
iv. determining an area under a curve of the intensities in function of the wavelength, representing the absorbance, of the absorbance spectrum A_{MEAS} at least in the wavelength range W_{MEAS},
v. estimating the varnish thickness using the area under the curve and reference values linking an area under the curve of an absorbance spectrum of the coating to a varnish coating thickness.

12: The method as recited in claim 11 wherein the steel substrate is an electrical steel.

13: The method as recited in claim 11 wherein the varnish coating has a thickness from 0.5 to 5 μm.

14: The method as recited in claim 11 wherein the varnish coating has a thickness from 0.5 to 2 μm.

15: The method as recited in claim 11 wherein the varnish coating is a water-based solution comprising 25 to 75 weight percent of resin, 5 to 15 weight percent of solvent and a balance consisting of water.

16: The method as recited in claim 11 wherein in step i., the light source L forms an angle from 53° to 59° with respect to the normal of said steel substrate.

17: The method as recited in claim 11 wherein in step i., the light source L includes wavelength from 1.0 to 5.0 μm and said wavelength range W_{MEAS} is at least from 1.0 to 5.0 μm.

18: The method as recited in claim 11 wherein in step i., the illumination source L and said moving coated steel substrate are spaced from 20 cm to 60 cm.

19: The method as recited in claim 11 wherein in step i., the illumination source L is configured to illuminate an area having a width as wide as the strip width and a length of at least 20 mm.

20: The method as recited in claim 11 wherein in step ii., the measure is done via a hyperspectral camera.
